(19) United States
(12) Patent Application Publication
(10) Pub. No.: US 2026/0118532 A1
(43) Pub. Date: Apr. 30, 2026

(54) TECHNIQUE FOR DETERMINING THE KINETIC ENERGY OF A HADRON BEAM

(71) Applicant: INSTYTUT FIZYKI JADROWEJ IM. HENRYKA NIEWODNICZANSKIEGO POLSKIEJ AKADEMII NAUK, Krakow (PL)

(72) Inventors: Wiktor PAROL, Krakow (PL); Pawel KULESSA, Wegrzce (PL); Adam KOZELA, Krakow (PL)

(21) Appl. No.: 19/158,425

(22) PCT Filed: Feb. 23, 2024
(86) PCT No.: PCT/PL2024/000007

§ 371 Date: Aug. 20, 2025

(30) Foreign Application Priority Data
Feb. 28, 2023 (PL) P.443931

(51) Int. Cl. G01T 1/29; G01T 7/00; H05H 13/00

(52) U.S. Cl. CPC G01T 1/29; G01T 7/005; H05H 13/005

(57) ABSTRACT

A technique for determining the kinetic energy of a hadron beam using elements of the particle time of flight method, where all amplitudes for the measured signals S^{A}(k) and S^{B}(k) are recorded simultaneously from two detectors (A) and (B) located at a precisely defined distance L from each other and connected to a processing unit enabling the analysis of images recorded by both detectors, placed along the line of the studied hadron beam, over a period of time corresponding at least to 100 times the theoretical value for the time of flight of a hadron beam particle between the detectors (A) and (B), with time resolution at least on the level of 0.5 ns.

The subject of the invention is a method for determination of kinetic energy of a hadron beam with high precision, thus enabling effective use of such a beam in experimental physics, for therapeutic purpose, as well as in some highly specialised industrial technologies which require a well-defined energy beam in the range over 500 keV.

Devices of various design, the so-called accelerators, are used to generate ionising radiation beams, wherein they accelerate charged particles, imparting them with high energy. The particles are accelerated using electric field and the acceleration method involves acting on the particle beam e.g. with constant voltage, with high frequency, induced or multi-stage, while magnetic field is used to direct the accelerated particles along the respective path or focus the particles. Magnetic field is generated using electromagnet blocks located along the accelerator line/circuit.

A number of particle acceleration methods is known, e.g. electrostatic acceleration, using standing or travelling wave (resonance cavity), as well as in plasma. Each of the methods requires complicated accelerating structures involving i.e. electromagnets operating at very high frequencies, on the order of several GHz. Magnets focusing and correcting the beam path and its diagnostics elements are installed between the accelerating structures. Each interaction of the hadron beam with the generated electromagnetic fields results in an energy change of the hadron beam. Parameter change (instability) of the devices accelerating and shaping the beam, as well as collisions between the particles or passing through a degrader (obstacle) in any form results in unspecified influence on the energy of the hadron beam. The use of hadron beams in experimental physics, for therapeutic purposes, as well as in some highly specialised industrial technologies requires the kinetic energy of the used beams to be extremely precisely defined or measured. It is possible to calculate the kinetic energy of the hadron beam used theoretically, on the basis of the parameters of the accelerator used, but sometimes this yields a coarse approximation with inadequate accuracy. It is then necessary to determine or measure the actual value of kinetic energy of the beam before it is used for experimental, therapeutic or industrial purposes. The analysis of the state of the art also indicates that intensive search for solutions aimed at a method of effective and precise measurement or determination of the kinetic energy of a hadron beam intended for use in applications which require accurate, precise and reliable data on the kinetic energy of the used beam result in a number of protected inventive solutions and scientific information disclosing the related solutions.

The patent document EP3155456 B1 discloses a system for measurements of a mono-energy hadron beam, characterised in that it includes the first detection unit including a planar sensor with a detection area, divided into a pixel matrix. Each pixel is adapted to provide a transit signal indicating particle flight and a counting system coupled with the sensor in order to provide output signal indicating the number of particles, e.g. of a beam passing through the aforementioned detection area over a time range, according to the transit signals provided by the aforementioned pixels and a second detection unit placed below the first detection unit and containing at least one ionisation detector to provide the output signal proportional to the total charge Qion released by the beam in the ionisation detector over the aforementioned time range. In the aforementioned solution, energy is measured on the basis of recording of the number of particles in one detector and their total energy loss resulting from ionisation in the other detector. The time interval is a period of time, during which a measurement is carried out.

The invention disclosed in the patent document CN102488971 B is related to dynamic proton imaging in real time and a radiotherapy imaging method. According to this method, proton energy is received by a detector in the form of a thin-layer transistor made of amorphous silicon with a caesium iodide film and subjected to a digital-analogue conversion in order to create an image. This method is characterised in that the proton energy is obtained twice, once before proton emission to the detected object and again, after proton passage through the examined object. The data obtained from double acquisition is processed in order to generate an image.

The publication by Z. Kormány, titled.: “A new method and apparatus for measuring the mean energy of cyclotron beams”, Nuclear Instruments and Methods m Physics Research A 337 (1994) 258-264, discloses a method of measurement of the average energy of a beam obtained from the CV28 cyclotron at KFA Jülich. This method uses two capacitive transducers installed along a straight line, such that the lower transducer may be moved along the beam axis. The measurement is carried out fully on-line and a personal computer controls the position of the probe and evaluates the signal generated by the HF detector electronics. The solution disclosed in this work is based on the TOF (Time of Flight) measurement method. This method applies only to a cyclotron beam divided into packets. This method measures the time of flight for complete packets, and the average beam energy is obtained as the result.

The patent document U.S. Pat. No. 10,792,517 B2 discloses a method and a device used to determine the status of a positively charged particle, such as a proton, for use in imaging of a patient tumour before and/or simultaneously with a cancer therapy. The imaging system includes a transport path for positively charged particles, sequentially passing through the patient, the first time of flight detector and, having flown over a distance of the path, at least to the second time of flight detector using time between the detection of the time of flight and the path length in the first and the second detector in order to determine the energy loss of the particle, which is compared with the known energy of the incipient beam and used to generate a tumour image.

The international patent application WO2019197593 A1 discloses a time of flight (TOF) system used to measure the pulse energy of a hadron beam, wherein each pulse of the beam is ordered as a series of packets of charged particles, wherein these packets are repeated with a frequency in the range of radio frequency. The system includes the first detector, the second detector and the third detector located along the beam path, wherein each of the detector is configured to determine the passage of a charged particle packet and to provide the output signal which depends on the phase of the detected packet. The second detector is located at the first distance from the first detector, while the third detector is located at the second distance from the second detector. The first distance is determined such that the time of flight of the beam from the first detector to the second detector is approximately equal to or shorter than the packet repeating period, and wherein the second distance is determined such that the time of flight of the beam from the second detector to the third detector is greater than a multiple of the beam repeating period, and a processing unit configured to calculate the phase shifts between the detector output signals and to calculate the pulse energy on the basis of the calculated phase shifts.

The publication by Wei Liu et al., titled: “A beam energy time-flying measurement system”, Cyclotrons and Their Applications 2007, Eighteenth International Conference, presented a beam energy measurement system using time of flight measurements for a packet of a beam with periodic structure separated from the SFC (Sector Focusing Cyclotron). This system operates on-line and the accuracy of the beam energy measurement exceeds 5‰.

The patent publication U.S. Pat. No. 4,229,704 A discloses a charged particle beam packet, which is controlled with a signal generated in response to beam passage and added to the reference signal with a phase shift. The sum of both signals is amplified, detected and used in a synchronous detector in order to obtain a comparison between the phase of the reference signal and of the signal reacting to the beam packet. This comparison is the error signal used to control the beam, including beam packet cycling.

The publication by M. Kisieliński, J. Wojtkowska, titled: “The proton beam energy measurement by a time-of-flight method”, NUKLEONIKA 2007; 52(1):3-5 discloses a simple TOF apparatus used to measure the energy of cyclotron protons. For the short distance of 165 cm between the capacitive probes, the accuracy of energy measurement for a proton beam is on the level of 1% for average packet currents higher than 200 nA and within the energy range of 20-30 MeV. The solution disclosed in this work is based on the time of flight (TOF) method. This method applies only to a cyclotron beam divided into packets. This method measures the time of flight for complete packets, and the average beam energy is obtained as the result.

Methods of determination of hadron beam energy known in the state of the art are complex, time-consuming, with measurement accuracy on the level of approximately 1% of the average beam energy. A significant limitation of the known method for measurements of hadron beam energy also lies in the fact that the methods apply to measurements of beams generated in a cyclotron, transported in packets, and fail in the case of continuous beams. As a consequence, it is no longer possible to measure the energy of a beam with very low intensity, as signals induced by individual packets fall below the detection threshold or if the acceleration technique does not generate such packets (continuous beam).

The technical problem challenged by the invention involves the development of a method for fast determination of the energy of a hadron beam with high accuracy, below 1%, which does not use complicated procedures and complicated apparatus and which enables efficient and repeated determination of the energy of the hadron beam, both for beams generated as packets and for beams generated continuously in order to monitor and correct the beam parameters.

The essence of the method of determination of kinetic energy of a hadron beam according to the invention, using elements of the particle time of flight method, executed in a system including a particle detector unit and a processing unit enabling the analysis of images recorded by particle detectors, equipped with an oscilloscope card with the minimum bandwidth of 200 MHz and with the minimum sampling frequency of 4 GS/s is characterised in that a simultaneous, continuous recording of signal amplitudes, S^{A} and S^{B}, obtained from the particle detector unit is started, wherein the particle detectors are located along the light of the examined hadron beam, the first detector (A) and the second detector (B), with identical parameters and specifications, located at a precisely defined distance L from each other and independently connected to the processing unit and forming a previously calibrated system for recording of the values if individual signal amplitudes S^{A} and S^{B}, which takes place with a time resolution of at least 0.5 ns.

The amplitudes of unit signals S^{A}(k) and S^{B}(k) from both detectors (A) and (B), recorded simultaneously for protons of the measured hadron beam, are saved in the calculation unit for a period of time corresponding to at least 100 times the theoretical time of flight of a single particle of the hadron beam between the detectors (A) and (B). S^{A} and S^{B} denote ordered sets of signals recorded during the period of measurement carried out by the detectors A and B. Whereas, S^{A}(k) and S^{B}(k) denote individual sampled signal points (single sampling intervals—“bins”). Simultaneous recording of the amplitudes of measured signals S^{A} and S^{B} from both particle detectors (A) and (B) is archived in buffers of the calculating unit. Simultaneous recording of each pair of signals obtained from detectors A and B is indexed using the same variable determining the recording step k, obtaining signal profiles S^{A}(k) and S^{B}(k). An initial analysis of the S^{A}(k) and S^{B}(k) signals is carried out and they are considered equal to zero below the specified noise level and these S^{A}(k) and S^{B}(k) are eliminated. This is followed by the analysis of the shape of individual signals S^{A}(k) and S^{B}(k) most frequently recorded for the protons of the measured beam and the shape pattern is determined for these signals, then signals deviating from this pattern are removed. After the end of the recording period for the amplitude signals S^{A}(k) and S^{B}(k) from both particle detectors (A) and (B), an analysis of statistical correlation of signal profiles for S^{A}(k) and S^{B}(k), left at both detectors by multiple particles is carried out. The analysis includes a shift of the recorded signal profile from the particle detector (B) with its recording basis step k, compared to the determined signal profile from the particle detector (A), until a maximum overlap of the signal profiles is obtained for the signals S^{A}(k) and S^{B}(k). The maximum overlap of the analysed signals means that the minimum total difference between the profile amplitudes for signals S^{A}(k) and Sb(k)^{B}(k) has been achieved at the specific step k, corresponding to the time resolution with which the signals are recorded.

The number of steps k, determined during a measurement, from k=0 to k=N, is used to determine the multiplicity of steps k designated as τ^{D}, o by which the signal S^{B}(k) is shifted against the signal S^{A}(k), such that the following function reaches its minimum:

$$R ( {τ}^{D} ) = \frac{1}{N - {τ}^{D}} {\sum }_{k = 0}^{N - {τ}^{D}} \vert {S}^{A} ( k ) - {S}^{B} ( k + {τ}^{D} ) \vert$$

where: τ^{D} is a variable determining the shift between the compared signal, which achieves discrete values from the interval (0, N).

The position of the global minimum of the R(τ^{D}) function and the values of τ^{D}ₘᵢₙ, at which the R(τ^{D}) function reaches the global minimum are determined. Knowledge of the τ^{D}ₘᵢₙ value enables determination of the time corresponding to the time of flight of hadrons between the detectors (A) and (B), expressed by the formula t=Δt*τ^{D}ₘᵢₙ, where Δt is the length of a single sampling interval (0.5 ns).

In order to improve the precision of kinetic energy determination for the hadron beam, the position of the global minimum of the continuous R(τ^{D}) function was specified more precisely by fitting the polynomial around the previously determined minimum, using the least squares method for the distance (|R(τ^{D})−ρ(τ^{D})|), where ρ designates the fitted polynomial. Next, the precise average time of flight of the hadron beam is determined according to the relationship t=Δt*τₘᵢₙ, where Δt is the length of a single sampling interval, while τₘᵢₙ designates the real number τ, for which the polynomial ρ(τ^{D}) fitted to the R(τ^{D}) reaches the minimum value. On the basis of known physical relationships, the value of kinetic energy for the studied hadron beam is determined from the obtained, precise time of flight t of the hadron beam between the detectors (A) and (B). The determined value of kinetic energy of the hadron beam is corrected with the known energy loss occurring during the passage through the first detector (A), by subtracting the literature value of energy losses in the used detector (A). Presentation of the determined energy value marks the end of the procedure used to determine the kinetic energy of the hadron beam and simultaneously, detectors (A) and (B) are removed from the path, along which the studied hadron beam moves.

Scintillation detectors placed along the line of the studied hadron beam are preferably used as particle detectors, such that the planes of the active part of the detectors are perpendicular to the direction of travel of the hadron beam.

The calibration measurement of the entire installation set up to execute the method of determination of kinetic energy of a hadron beam includes installation testing by carrying out individual measurements for detectors placed at a distance d=0, such that the active parts of both detectors are in contact and the system is considered calibrated when the determined, average time of flight for the hadrons reaches 0.

In order to eliminate the signals S^{A}(k) and S^{B}(k), for which the amplitude values are below the specified noise level, said noise level is determined in algorithmic calculations on the basis of the statistical distribution of the sampled amplitudes and Gaussian function fitting around the maximum count, followed by determination of the zero level for the mean value of the distribution and the noise level is determined as at least 3σ, where σ is the standard deviation from the mean value of said distribution. The reference shape is also determined for individual signals most frequently recorded for the protons of the measured signal beam, used to remove the S^{A} and S^{B} signals, as well as the signals deviating from the determined reference shape, from the ordered signal set. The pulse length and its integrated surface area are accepted as the conformity criterion, followed by the rejection (amplitude zeroing) of pulses by deviating at least 3σ from the mean value for at least one parameter forming the criterion.

The method of determination of hadron beam kinetic energy according to the invention is characterised by its high rate: the response follows measurement triggering almost immediately. This method enables measurement precision several times higher compared to the methods known in the art to be achieved. The method uses the analysis of overlapping of signals containing multiple pulses of many particles, thus increasing the measurement reliability compared to known solutions based on the phase difference between two similar pulses. The reliable measurement obtained using the method according to the invention enables the determination of the value for energy just before the location where the beam is used.

Additional benefits offered include the ability to measure energy of continuous beams and very low intensity beans generated by cyclotrons, for which capacitive methods are ineffective.

The method of determination of hadron beam kinetic energy is explained below using practical embodiments of the invention and the drawing, which shows, in

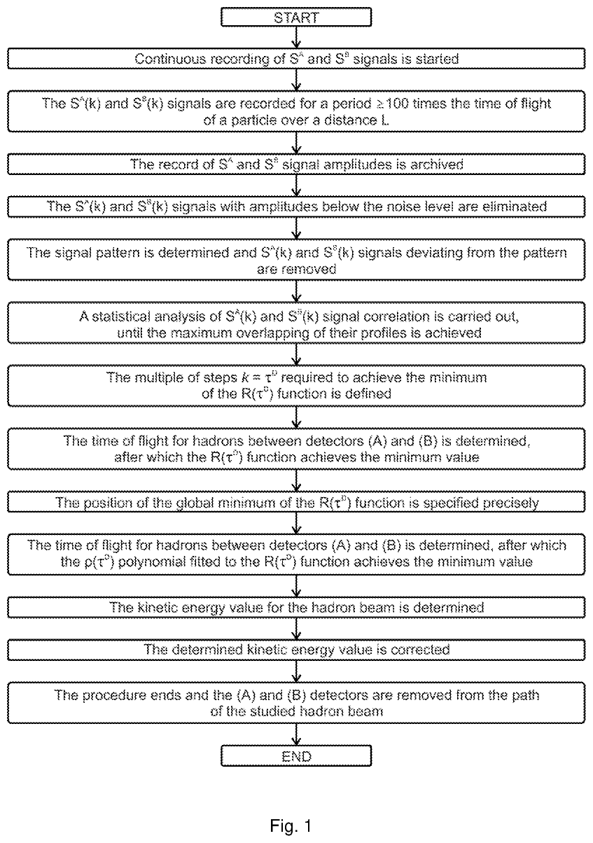

FIG. 1 presents the flow diagram of the algorithm of the method,

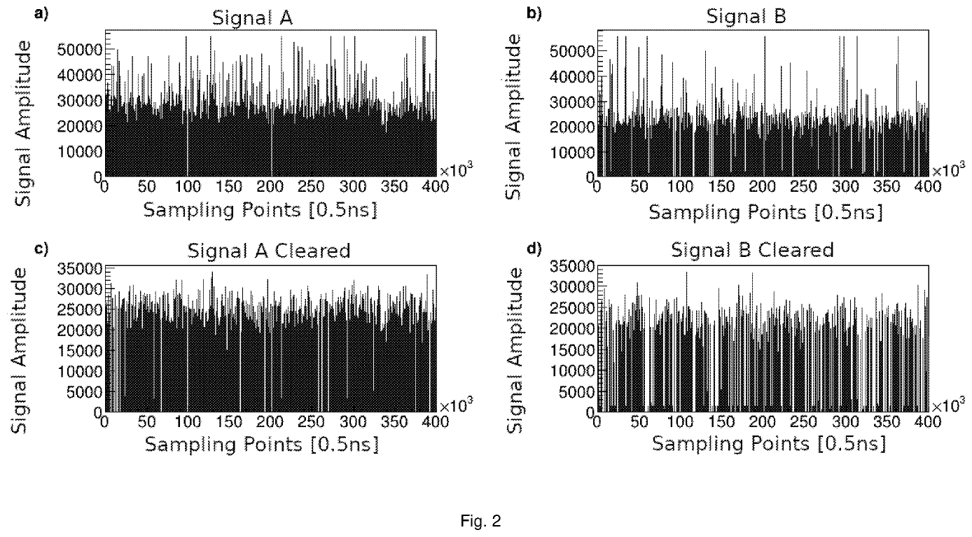

FIG. 2 presents example images of signals from both detectors acquired during a single measurement lasting wherein the top row shows signals from detectors (A) and (B) after the initial processing and saving in the buffers, while the bottom row shows signals from detectors (A) and (B) after the removal of signals from random particles from them on the basis of a shape analysis,

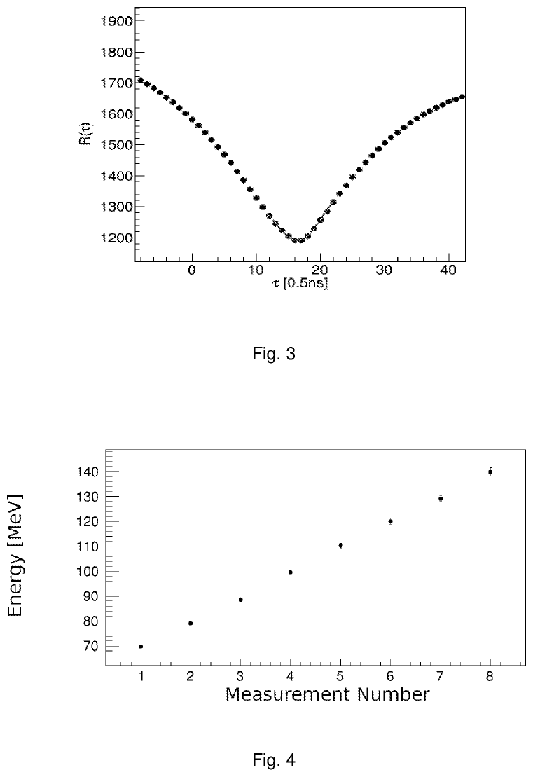

FIG. 3 shows the example values of the signal overlapping function R(τ^{D}) [points], which depends on the signal shift step from detector (B), and the maximum signal overlapping occurs at the location of the R(τ^{D}) function minimum,

FIG. 4 shows the results for a series of measurement of beam energy changed with a 10 MeV increment using a degrader, carried out at the experimental hall of the Bronowice Cyclotron Centre using the method according to the invention, and

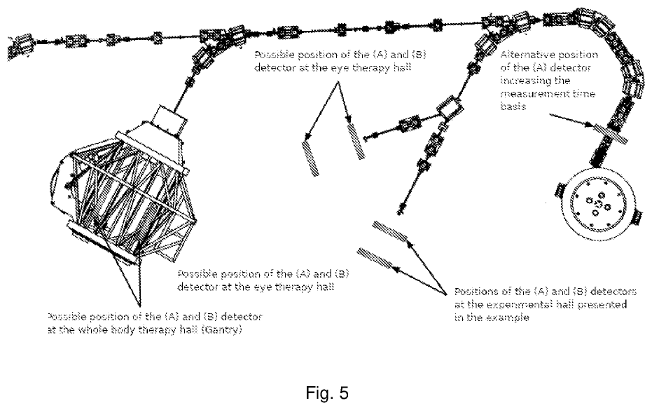

FIG. 5 schematically presents the locations of the (A) and (B) detectors in the line of the Proteus-235 cyclotron beam at Bronowice Cyclotron Centre.

### EXAMPLE 1

An example execution of the method of determination of hadron beam kinetic energy diffusion was carried out using a proton beam with the energy of 1.96 GeV and the current of approximately 1 pA, generated by the COSY cyclotron at Forschungszentrum Juliech.

The installation for execution of the method was assembled using two particle detectors And B. Both detectors used square scintillation plastic panels BICRON, 90×90 mm and 5 mm thick as the active material. The light excited by the passing hadron beam particles was read on one side using four silicon photoamplifiers (3 mm, C-Series by Omicron). The photoamplifier unit installed on the side of the active material panel and the scintillating material itself were optically insulated against the ambient light as a standard.

The electric signal acquired from photoamplifiers was sent through concentric BNC cables to two channels of the oscilloscope card WaveSurfer 3024z installed in the central processing unit. The oscilloscope card channels were set to the single time interval of 5 ms recording, with a resolution of 0.5 ns per single bin (sampling interval). The signal from each detector was saved in a separate memory buffer. Each buffer was designed to store at least 1.0×10⁷ points. The signal profiles saved in the buffers and generated in the detectors by the passing particles of the measured hadron beam were analysed using an algorithm executing the method of determination of kinetic energy of the hadron beam.

The distance between the detectors was set as d=7.93 m. A calibration measurement involving individual measurements for detectors set at a distance of d=0, which means that the active parts of both detectors were in contact. The calibration measurement was carried out in order to verify that the records of signals from both detectors do not show any delays related to incorrect design of the system and is recorded synchronously in both channels as a consequence.

The execution of the method of determination of kinetic energy of a hadron beam was preceded by the placement of detectors along the line of the examined hadron beam at a distance d=7.93 m, followed by the emission of a proton beam with the energy of 1.96 GeV.

The execution of the method of determination of kinetic energy of a hadron beam began with starting the synchronised, simultaneous and continuous recording of the values of individual signal amplitudes S^{A} and S^{B} from both particle detectors (A) and (B). The individual (k-th) values of signal amplitudes S^{A}(k) and S^{B}(k) were sampled and recorded every 0.5 ns over a period of 5 ms. The recording of individual sampling points for both signals was carried out synchronously and indexed with the save variable determining the recording step k, as a result of signal recording throughout the entire measurement interval forming the profiles of signals S^{A}(k) and S^{B}(k). An initial analysis of the recorded signals was carried out and the zero level was determined for the signals, together with the noise level and the amplitudes of individual signal fragments with a value lower than the threshold limit were removed (zeroed). At the same time, the initial analysis determined the characteristic pulse profile and the profile most frequently corresponding to the signals generated by protons with the energy of the studied beam, and signals deviating from the determined signal reference profile for a single particle were zeroed (removed) from the recorded signals S^{A} and S^{B}. The pulse length and its integrated surface area were accepted as the conformity criteria. Pulses deviating by 3σ from the mean value of at least one parameter comprising the criterion were rejected (the amplitudes were zeroed).

After the initial analysis, a statistical analysis was carried out for the correlation of S^{A} and S^{B} signal profiles left in the detectors by many particles. Each of the signal profiles comprised an array of N=1.0×10⁷ saved values of individual S^{A}(k) and Sb(k)^{B}(k) amplitudes, numbered using a shared k index. The signal profile correlation analysis involved a shift of the recorded signal profile S^{B}(k) by shifting the index using individual natural numbers τ^{D} from the range [0, N), compared to the fixed signal profile S^{A}(k), at the same time adding together the amplitude difference for the entire signal and obtaining a set of values R(τ^{D}) such that:

$$R ( {τ}^{D} ) = \frac{1}{N - {τ}^{D}} {\sum }_{k = 0}^{N - {τ}^{D}} \vert {S}^{A} ( k ) - {S}^{B} ( k + {τ}^{D} ) \vert$$

Next, we select a τ^{D}ₘᵢₙ value such that R(τ^{D}ₘᵢₙ) assumes the lowest value of all R(τ^{D}). The value of τ^{D}ₘᵢₙ=57 was obtained.

This defined the global function minimum for the value τ^{D}ₘᵢₙ, which is the best fit to the average time of flight of hadrons between the detectors, expressed with the formula t=Δt*τ^{D}ₘᵢₙ, where Δt is the length of a single sample interval (0.5 ns). The value of t=28.5±0.5 ns was obtained.

The previously obtained value of time shift was made more precise by further specifying the location of the minimum (τₘᵢₙ) of the continuous function R(τ) obtained by fitting a 5th order (ρ(τ)) polynomial to R(τ^{D}ₘᵢₙ) using the least square method for length |R(τ^{D})−ρ(τ^{D})|.

Next, the average time of flight of particles was determined again, using the relationship t=Δt*τₘᵢₙ where Δt is the length of a single sampling interval, while τₘᵢₙ means a real number τ, for which the ρ(τ) polynomial fitted to the R(τ) function, and thus the R(τ) function reach the minimum value. The value of t=27.98+/−0.07 ns was obtained.

The objective of the statistical analysis of signal profile correlation for S^{A} and S^{B} was to obtain the maximum overlap of the signal profiles S^{A} and S^{B}, which means that the minimum of the total sum of amplitude difference for the signal profiles S^{A}(k) and S^{B}(k) was reached over all sampling intervals k.

The obtained results provided the basis for determination of the kinetic energy value for the hadron beam, using the obtained time of flight t between the scintillation detectors A and B on the basis of known physical relationships for the given hadron beam.

$${E}_{k i n} = {m}_{0} {c}^{2} ( \frac{1}{\sqrt{1 - {( \frac{v}{c} )}^{2}}} - 1 )$$

where c is the speed of light, m₀ the particle mass, and the particle velocity is

$$v = \frac{L}{t} ,$$

results from the knowledge of the time of flight t of this particle between two detectors A and B located at a specified distance L from each other.

The determined value of kinetic energy of the hadron beam was corrected with the known energy loss occurring during the passage through the detector A, by adding the literature value of energy losses in the used detector to the achieved value for energy.

The value of the kinetic energy of a hadron beam of 1.95+/−0.1 GeV was obtained and the scintillation detectors A and B were removed from the motion path of the studied hadron beam.

### EXAMPLE 2

The example method of determination of the kinetic energy of a hadron beam was executed using a proton beam generated by the Proteus-235 cyclotron at the Bronowice Cyclotron Centre. The output energy of the cyclotron beam was always 226 MeV and was reduced to the desired value using a specially prepared degrader set. The initial current of the beam was 1 nanoampere and was also reduced on a degrader. The tests were performed for energy in the 70-140 MeV range with a 10 MeV increment, while the beam current was reduced to several picoamperes.

The installation for execution of the method according to the invention was assembled using two particle detectors. Both detectors used square panels made of scintillating plastics BICRON as the active material, sized at 30×30 mm and 5 mm thick. The light excited by the passing hadron beam particles was read on one side using one silicon photoamplifiers (3 mm, C-Series by Omicron). Both the panel made of active material and the photoamplifier installed on its side were optically insulated from ambient light as a standard, using material with known thickness. Example 2 involved the execution of the kinetic energy determination method for eight hadron beams, in the energy range of 70-140 MeV.

The distance between the detectors was set as d=2.66 m. A calibration measurement was carried out analogously to the description in Example 1. The method of kinetic energy determination for individual hadron beams started with emitting a proton beam with an energy of 70 MeV, for the first studied beam. The subsequent beams had their energy increased by 10 MeV, up to the eighth energy level of 140 MeV.

The method of determination of kinetic energy of the studied hadron beam involved synchronised, simultaneous and continuous recording of the values of individual signal amplitudes S^{A} and S^{B} from both particle detectors (A) and (B). The individual (k-th) values of signal amplitudes S^{A}(k) and S^{B}(k) were sampled and recorded every 0.5 ns over a period of 2 ms. The recording of individual sampling points for both signals was carried out synchronously and indexed with the save variable determining the recording step k, as a result of signal recording throughout the entire measurement interval forming the profiles of signals S^{A}(k) and S^{B}(k). An initial analysis of the recorded signals was carried out and the zero level was determined for the signals, together with the noise level and the amplitudes of individual signal fragments with a value lower than the threshold limit were removed (zeroed). At the same time, the initial analysis determined the characteristic pulse profile and the profile most frequently corresponding to the signals generated by protons with the energy of the studied beam, and signals deviating from the determined signal reference profile for a single particle were zeroed (removed) from the recorded signals S^{A} and S^{B}. The pulse length and its integrated surface area were accepted as the conformity criteria. Pulses deviating by 3σ from the mean value of at least one parameter comprising the criterion were rejected (the amplitudes were zeroed). At the end of the initial analysis, a statistical analysis was carried out for the correlation of S^{A} and S^{B} signal profiles left in the detectors by many particles. Each of the signal profiles comprised an array of N=4.0×10⁶ saved values of individual S^{A}(k) and Sb(k)^{B}(k) amplitudes, numbered using a shared k index. The signal profile correlation analysis involved a shift of the recorded signal profile S^{B}(k) by shifting the index using individual natural numbers τ^{D} from the range [0, N), compared to the fixed signal profile S^{A}(k), at the same time adding together the amplitude difference for the entire signal and obtaining a set of values R(τ^{D}) such that:

$$R ( {τ}^{D} ) = \frac{1}{N - {τ}^{D}} {\sum }_{k = 0}^{N - {τ}^{D}} \vert {S}^{A} ( k ) - {S}^{B} ( k + {τ}^{D} ) \vert$$

Next, the τ^{D}ₘᵢₙ value was determined, such that R(τ^{D}ₘᵢₙ) assumes the lowest value of all R(τ^{D}). The τ^{D}ₘᵢₙ values presented in Table 1 were obtained for individual beams:

TABLE 1

| | Hadron beam | |
|---|---|---|
| No. | energy [MeV] | τ^{D}_{min value} |
| 1. | 70 | 50 |
| 2. | 80 | 48 |
| 3. | 90 | 44 |
| 4. | 100 | 42 |
| 5. | 110 | 40 |
| 6. | 120 | 39 |
| 7. | 130 | 38 |
| 8. | 140 | 37 |

This defined the global function minimum for the value τ^{D}ₘᵢₙ, which is the best fit to the average time of flight of hadrons between the detectors, expressed with the formula t=Δt*τ^{D}ₘᵢₙ where Δt is the length of a single sample interval (0.5 ns). The t values presented in Table 2 were obtained for individual beams:

TABLE 2

| | Hadron beam | |
|---|---|---|
| No. | energy [MeV] | t value |
| 1. | 70 | 25.0 +/− 0.5 |
| 2. | 80 | 24.0 +/− 0.5 |
| 3. | 90 | 22.0 +/− 0.5 |
| 4. | 100 | 21.0 +/− 0.5 |
| 5. | 110 | 20.0 +/− 0.5 |
| 6. | 120 | 19.5 +/− 0.5 |
| 7. | 130 | 19.0 +/− 0.5 |
| 8. | 140 | 18.5 +/− 0.5 |

The previously obtained value of time shift was made more precise by further specifying the location of the minimum (τₘᵢₙ) of the continuous function R(τ) obtained by fitting a 5th order (ρ(τ)) polynomial to R(τ^{D}ₘᵢₙ) using the least square method for length |R(τD)−ρ(τ^{D})|.

Next, the average time of flight of particles was determined again, using the relationship t=Δt*τₘᵢₙ, where Δt is the length of a single sampling interval, while τₘᵢₙ means a real number τ, for which the ρ(τ) polynomial fitted to the R(τ) function, and thus the R(τ) function reach the minimum value. The t values presented in Table 3 were obtained for individual beams:

TABLE 3

| | Hadron beam | |
|---|---|---|
| No. | energy [MeV] | t value |
| 1. | 70 | 24.89 +/− 0.08 |
| 2. | 80 | 23.46 +/− 0.11 |
| 3. | 90 | 22.12 +/− 0.09 |
| 4. | 100 | 20.98 +/− 0.08 |
| 5. | 110 | 20.15 +/− 0.07 |
| 6. | 120 | 19.44 +/− 0.09 |
| 7. | 130 | 18.82 +/− 0.06 |
| 8. | 140 | 18.20 +/− 0.09 |

The obtained results were used as the basis for determination of the kinetic energy value for the hadron beam using the obtained time of flight t between the scintillating detectors A and B, according to the known physical relationships for the given hadron beam.

The value of kinetic energy of the hadron beam was corrected with the known energy loss occurring during the passage through the detector A, by adding the literature value of energy losses in the used detector to the achieved value for energy.

The results of energy determination for a series of measurements for the measured beams are presented in FIG. 5.

The kinetic energy determination procedures carried out for hadron beams in the examples according to the method according to the invention resulted in kinetic energy values for 9 hadron beams. The obtained results differed by <1% compared to the energy value determined using other, more complicated methods.

The use of the method of determination of hadron beam kinetic energy according to the invention enables the replacement or supplementation of difficult and complex methods previously used to determine the kinetic energy of hadron beams and surveillance expansion during the use of hadron beams to be achieved, which should contribute to the improved reliability of effects achieved in scientific, therapeutic and technical applications.

1. Technique for determining the kinetic energy of a hadron beam using elements of the particle time of flight method, executed in a particle detector unit system equipped with a processing unit enabling the analysis of images recorded by the particle detectors and including an oscilloscope card with a minimum bandwidth of 200 MHz and a sampling frequency of at least 4 GS/s, characterised in that
simultaneous, continuous recording of amplitude values for the S^{A} and S^{B} signals from the particle detector unit is started, with the first (A) and the second (B) detectors placed along the line of the studied hadron beam, with simultaneous parameters and specifications, located at a precisely determined mutual distance L and independently connected with the processing unit and comprising a previously calibrated system for execution of recording of the values of individual signal amplitudes S^{A} and S^{B}, which is executed with time resolution on the level of at least 0.5 ns,
all amplitudes of the measured signals S^{A}(k) and S^{B}(k) from both detectors (A) and (B) are recorded simultaneously for a period of time corresponding to at least 100 times the theoretical time of flight of a single particle of the hadron beam between the detectors (A) and (B),
the simultaneous records of amplitudes of the measured S^{A} and S^{B} signals from both particle detectors (A) and (B) are archived, and individual sampling points for both signals are recorded synchronously and indexed using the same variable specifying the recording step k, obtaining signal profiles S^{A}(k) and S^{B}(k),
the amplitude value for signals S^{A}(k) and S^{B}(k) lower than the specified threshold value are considered to be zero and are eliminated,
an analysis of the shape of individual signals S^{A}(k) and S^{B}(k) most frequently recorded for the protons of the measured beam is carried out and the shape pattern is determined for these signals, followed by the removal of signals deviating from this pattern,
after the end of the recording period for amplitudes of signals S^{A}(k) and S^{B}(k) from both particle detectors (A) and (B), an analysis of the statistical correlation for the signal profiles for S^{A}(k) and S^{B}(k), left at both detectors by multiple particles, is carried out by shifting the recorded signal profile recorded from the particle detector (B) with its recording basis step k, compared to the constant signal profile from the particle detector (A), until the maximum overlap of signal profiles is achieved for S^{A}(k) and S^{B}(k), which is equivalent to achieving the minimum total difference between the amplitudes of signal profiles for S^{A}(k) and S^{B}(k), at the specified step k, corresponding to the time resolution used to record the signals,
the number of steps k, determined during a measurement, from k=0 to k=N, is used to determine the multiplicity of steps k designated as τ^{D}, by which the signal S^{B}(k) is shifted compared to the signal S^{A}(k), such that the following function reaches its minimum:
$$R ( {τ}^{D} ) = \frac{1}{N - {τ}^{D}} {\sum }_{k = 0}^{N - {τ}^{D}} \vert {S}^{A} ( k ) - {S}^{B} ( k + {τ}^{D} ) \vert$$
where: τ^{D} is a variable defining the shift between the compared signals and it assumes discreet values in the (0, N) range,
the location of the global minimum of the R(τ^{D}) function and the value τ^{D}ₘᵢₙ, corresponding to the time of flight of hadrons between the detectors (A) and (B) expressed using the formula t=Δt*τ^{D}ₘᵢₙ, where Δt is the length of a single sample interval (0.5 ns), are determined,
the position of the global minimum of the continuous R(τ^{D}) function is specified more precisely by fitting the polynomial around the previously determined minimum, using the least squares method for the distance (|R(τ^{D})−ρ(τ^{D})|), where ρ designates the fitted polynomial,
the average time of flight of the hadron beam is determined according to the relationship, t=Δt*τₘᵢₙ, where Δt is the length of a single sampling interval, while τₘᵢₙ designates the real number τ, for which the ρ(τ^{D}) polynomial fitted to the R(τ^{D}) function reaches the minimum value,
the kinetic energy value for the hadron beam is determined using the obtained time of flight t between the detectors A and (B) according to the known physical relationships for the given hadron beam,
the determined value of kinetic energy of the hadron beam is corrected with the known energy loss occurring during the passage through the first detector (A), by subtracting the literature value of energy losses in the used detector (A),
the procedure of kinetic energy determination for a hadron beam ends by presenting the determined energy value and with the removal of the (A) and (B) detectors from the motion path of the studied hadron beam.

2. A method according to claim 1, characterised in that scintillation detectors placed along the line of the studied hadron beam are used as particle detectors, such that the planes of the active part of the detectors are perpendicular to the direction of travel of the hadron beam.

3. A method according to claim 1, characterised in that the calibration measurement involves testing of the entire installation set up to execute the method of determination of kinetic energy of a hadron beam by carrying out individual measurements for detectors placed at a distance d=0 such that the active parts of both detectors are in contact and the system is considered as calibrated when the determined, average time of flight of the hadrons reaches 0.

4. A method according to claim 1, characterised in that the noise level is determined through algorithm calculations based on the statistical distribution of the sampled amplitudes and fitting the Gaussian function around the maximum count, followed by determination of the zero level for the average value of the distribution and of the noise as at least 3σ, where σ designates the standard deviation from the mean value of this distribution.

5. A method according to claim 1, characterised in that a reference profile is determined for individual signals, most frequently recorded for protons of the measured signal beam, and the pulse length and its integrated surface area are accepted as the conformity criterion, followed by the rejection (amplitude zeroing) of pulses deviating by at least 3σ from the mean value for at least one parameter comprising the criterion.
